(19) United States
(12) Patent Application Publication
(10) Pub. No.: US 2023/0160258 A1
(43) Pub. Date: May 25, 2023

(54) ROLLING SHUTTER PROTECTION

(71) Applicant: Eyal KAHLON, HULON (IL)

(72) Inventor: GOLAN PERETZ, TZUKEI YAM (IL)

(21) Appl. No.: 17/910,981

(22) PCT Filed: Mar. 21, 2021
(86) PCT No.: PCT/IL2021/050312

§ 371 Date: Sep. 12, 2022

(30) Foreign Application Priority Data
Mar. 22, 2020 (IL) 273502

(51) Int. Cl. E06B 9/17; E06B 9/58; E06B 9/80

(52) U.S. Cl. CPC E06B 9/17007; E06B 9/58; E06B 9/80; E06B 2009/801

(57) ABSTRACT

A rolling shutter mechanism and a method for protecting a rolling shutter assembly covering an opening. The rolling shutter assembly includes a shutter, guide rails, a shutter roller and a locking mechanism. The rolling shutter mechanism includes protecting means to cover the rolling shutter assembly. The protecting means include a protecting box covering the shutter roller, protecting frames covering the guide rails and a protecting unit covering the lower part of the shutter when it is in its closed position.

### FIELD OF THE INVENTION

The present invention relates to rolling shutters and in particular to a protection system for rolling shutters.

### BACKGROUND OF THE INVENTION

Such rolling shutters are typically used for covering openings such as doors and windows of entrances and commercial cabinets or cupboards for holding merchandise in homes, stores and places of business. Some of the rolling shutters are locked in order to prevent burglary. The system for locking the rolling shutters includes attaching a lock with a key or an automatic latch lock mechanism. The automatic latch lock mechanism prevents the rolling shutter from being lifted back up, therefore it locks the rolling shutter.

A lock with a key may cause damage to the rolling shutter, and in addition, it can also be destroyed relatively easily and quickly by breaking the lock, since it is accessible. An automatic latch lock mechanism may be destroyed by a burglar when its location is accessible, via the weak points of the rolling shutter assembly exposed for burglary, and as a result the rolling shutter assembly can be dismantled or broken.

There is a crate at the top part of the mechanism, storing the engine, the automatic latch lock if existed, and the shutters when the rolling shutter is at its open position. This upper crate is accessible, therefore the rolling shutter, the locking mechanism and the engine can be dismantled or broken via the upper crate.

Another weak point of the rolling shutter mechanism is the guide rails of the rolling shutter mechanism, which are accessible and therefore can be broken by applying force with a tool, such as a crowbar or another. When the guide rails are broken, it is easy to move the rolling shutter and break in.

A further weak point is the bottom of the rolling shutter, which is accessible and therefore can be broken by applying force with a tool as well. The result is a broken locking mechanism, and therefore an opportunity to lift the rolling shutter and break in.

It is an object of the present invention to provide a rolling shutter with a locking and protection mechanism that significantly reduces or overcomes the aforementioned disadvantages. Furthermore, it is an object of the present invention to provide a method of securing and covering the rolling shutter and the locking mechanism, therefore protecting it from an easy access and burglary, which substantially overcomes these disadvantages.

### SUMMARY OF THE INVENTION

In accordance with the present invention, there is provided a rolling shutter mechanism for protecting a rolling shutter assembly covering an opening, the rolling shutter assembly including:
a shutter rolled between an open and closed position, having at least two slats;
guide rails to guide the at least two slats between the said closed and open positions;
a shutter roller to roll up and down the shutter when moved between said closed and open positions and store the shutter rolled in its open position;

a locking mechanism to lock the rolling shutter in its closed position;

wherein the rolling shutter mechanism has protecting means to cover the rolling shutter assembly; wherein the protecting means include protecting frames covering the guide rails.

In accordance with embodiments of the present invention, the protecting means further include a protecting box covering the shutter roller.

In accordance with embodiments of the present invention, the protecting means further include a protecting unit located at the lower part of the opening, the protecting unit covers the lower part of the shutter when it is in its closed position.

In accordance with embodiments of the present invention, the protecting means are attached to surfaces adjacent the opening.

In accordance with embodiments of the present invention, the protecting means are attached to the surfaces by screws.

In accordance with embodiments of the present invention, the protecting frames are generally rectangular in shape.

In accordance with embodiments of the present invention, the protecting box and the protecting unit are generally “U” shaped.

In accordance with embodiments of the present invention, the protecting frames are further attached to a contact unit.

In accordance with embodiments of the present invention, the protecting unit is further attached to an attachment unit.

In accordance with embodiments of the present invention, the attachment unit is generally rectangular in shape.

In accordance with embodiments of the present invention, the protecting means are attached to the surfaces by adhesive material.

In accordance with embodiments of the present invention, the protecting means are attached to the surfaces by the screws, the contact unit, the attachment unit and adhesive material.

In accordance with embodiments of the present invention, the protecting means are generally made of metal.

There is also provided in accordance with embodiments of the present invention a method for protecting a rolling shutter assembly for covering an opening, the rolling shutter assembly having

a shutter rolled between an open and a closed position, at least two slats, shutter roller, guide rails and locking mechanism; the method includes the steps of:

(i) providing protecting means to cover the rolling shutter assembly; the protecting means include a protecting box, protecting frames and a protecting unit;

(ii) placing the protecting box on top of the shutter roller and attaching the protecting box to at least one mounting surface adjacent the opening, wherein the protecting box covers the shutter roller;

(iii) placing the protecting frames on top of the guide rails and attaching the protecting frames to at least one contact surface adjacent the guide rails and the opening, wherein the protecting frames cover the guide rails;

(iv) placing and attaching the protecting unit to at least one abutment surface at the lower part of the opening, wherein the protecting unit covers the shutter when it is in its closed position.

In accordance with embodiments of the present invention, the method for protecting a rolling shutter assembly further includes in step (iii): attaching the protecting frames to at least one contact surface adjacent the guide rails and the opening via adhesive material.

In accordance with embodiments of the present invention, the method for protecting a rolling shutter assembly further includes in step (iii): attaching a contact unit to at least one contact surface adjacent the opening.

In accordance with embodiments of the present invention, the method for protecting a rolling shutter assembly further includes in step (iii): attaching the protecting frames to the contact unit by at least one screw;

In accordance with embodiments of the present invention, the method for protecting a rolling shutter assembly further includes: attaching the protecting means to the surfaces by the screws, the contact unit, the attachment unit and adhesive material.

In accordance with embodiments of the present invention, the guide rails and the protecting frames are made and assembled as one unit.

The present invention has the preferred advantages as to a firm securing without any additional locking means. The protection of the system is installed in a simple manner, which does not require a great amount of time or money to install. The protection of the system can be installed on any type of locking mechanism, such as a lock and a key, an automatic locking system, or any other locking mechanism. Furthermore, the rolling shutter mechanism can be installed on a window, cabinet, door, or any system which includes a rolling shutter assembly. The rolling shutter mechanism can be installed even on a multiple amount of cupboards attached together, on a cabinet attached to a wall, on a cupboard attached to a cabinet, and so on. The rolling shutter mechanism can be further installed over an existing cupboard, window, cabinet or door with an existing rolling shutter assembly, or on a new cupboard window, cabinet or door designed for the rolling shutter mechanism with a new rolling shutter assembly. The rolling shutter mechanism can be further installed using guide rails with additional material that due to its shape allows the guide rails to further include protecting frames in a single unit.

Further or additional preferred advantages of the present invention are obvious from the general discussion above as well as the detailed discussion of the invention as provided below. In particular, the present invention prevents and/or significantly delays burglary and undesired damage to the rolling shutter assembly, by an improved protecting mechanism.

### BRIEF DESCRIPTION OF THE DRAWINGS

For a better understanding of the present invention and to show how the same may be carried out in practice, reference will now be made to the accompanying drawings, in which:

FIG. 1 is a perspective view of a rolling shutter mechanism for an opening of a cupboard according to the present invention;

FIG. 2 is a perspective view of the rolling shutter mechanism for an opening of a window according to the present invention;

FIG. 3 is a perspective exposed view of the rolling shutter mechanism shown in FIG. 1 with a swing lift up door, covering the top part, open;

FIG. 4 is a detailed exploded view of a protecting box and the upper part of the rolling shutter mechanism shown in FIG. 1;

FIG. 5 is a side view of an alternative protecting box to the protecting box shown in FIG. 4;

FIG. 6 is a side view of another alternative protecting box to the protecting box shown in FIG. 4;

FIG. 7 is a cross sectional view taken along the line VII-VII in FIG. 1;

FIG. 8 is a front view of alternative protecting frames to the protecting frames shown in FIG. 7;

FIG. 9 is a front view of other alternative protecting frames to the protecting frames shown in FIG. 7;

FIG. 10 is a cross sectional view taken along the line X-X in FIG. 3 with a lock key added;

FIG. 11 is a side exposed view of the lower part of the rolling shutter mechanism according to the present invention;

FIG. 12 is a side view of an alternative protecting unit to the protecting unit shown in FIG. 11;

FIG. 13 is a side view of another alternative protecting unit to the protecting unit shown in FIG. 11; and

FIG. 14 is a side view of an alternative attachment unit to the attachment unit shown in FIG. 11.

FIG. 15 is a side view of other alternative protecting frames to the protecting frames shown in FIG. 7 that include guide rails.

FIG. 16 is a side view of other alternative protecting frames to the protecting frames shown in FIG. 7 that include guide rails.

### DETAILED DESCRIPTION OF THE PRESENT INVENTION

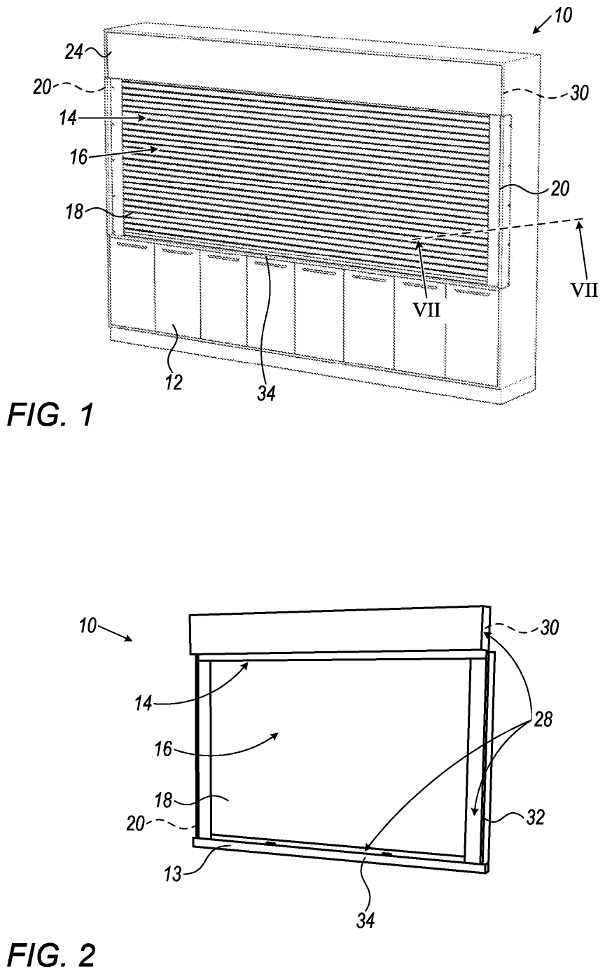

Attention is drawn to FIGS. 1 and 2, showing a rolling shutter mechanism 10 in accordance with the present invention. The rolling shutter mechanism 10 is used for covering openings such as doors and windows of entrances and commercial cabinets for holding merchandise in homes, stores and places of business, for example. An example of such a cupboard is seen in the figures, marked as 12, or an example of a window 13 can be seen in FIG. 2. Therefore, the cupboard 12 in this description may represent the window 13, a cabinet, a wall or any other structure to which the opening is attach. The rolling shutter mechanism 10 can cover and protect any other opening, of a door, glass-fronted display cabinet, or any other structure in a need to be covered. The rolling shutter mechanism 10 has a rolling shutter assembly 14. The rolling shutter assembly 14 includes a shutter 16, having at least two slats 18. The shutter 16 is rolled between an open and closed positions. The rolling shutter assembly 14 further includes guide rails 20. The guide rails 20 are generally “U” shaped and guide the slats 18 between the closed and open positions.

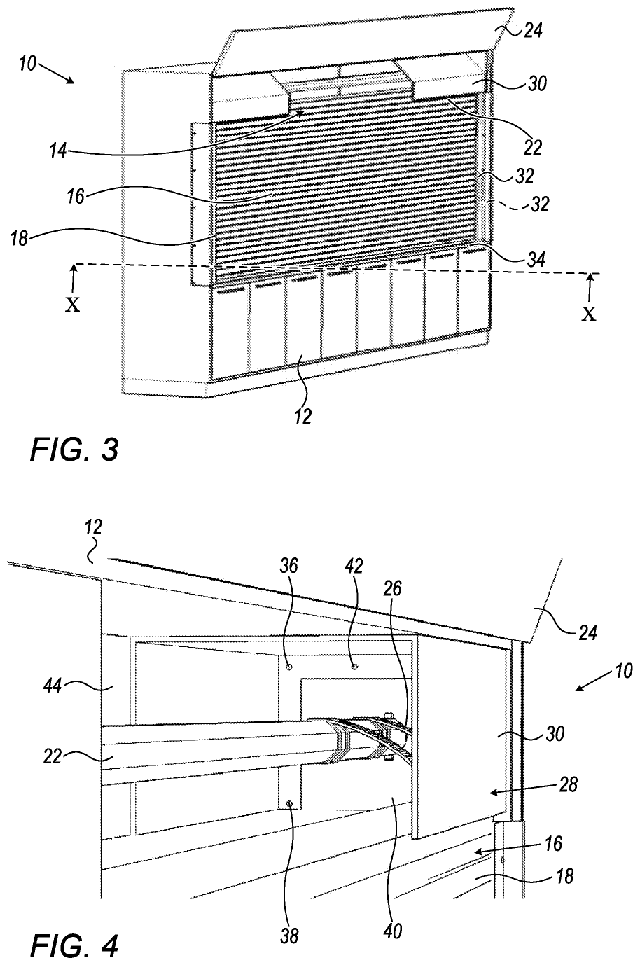

Attention is drawn to FIG. 3. The rolling shutter assembly 14 has a shutter roller 22 to roll up and down the shutter 16 when moved between said closed and open positions. FIG. 1 shows a swing lift up door 24 covering the top part of the rolling shutter mechanism 10, while FIG. 3 shows the swing lift up door 24 open. The shutter roller 22 stores the engine (not seen), if exists, and stores the shutter 16 rolled in its open position.

Attention is now drawn to FIG. 4. The rolling shutter assembly 14 has a locking mechanism 26 in order to lock the shutter 16 in its closed position. Alternatively, the locking mechanism can be a simple lock and a key, to lock manually, as can be seen in FIG. 10, or any other locking mechanism to prevent from opening the rolling shutter mechanism 10 and break in.

The rolling shutter mechanism 10 has protecting means 28 in order to protect and cover the rolling shutter assembly 14. The protecting means 28 are located in general in three different locations in the rolling shutter mechanism 10, in order to protect the most vulnerable spots of the rolling shutter assembly 14. The protecting means 28 include a protecting box 30 covering the shutter roller 22, protecting frames 32 covering the guide rails 20, and a protecting unit 34 covering the lower part of the shutter 16, when it is in its closed position. The protecting means 28 may be composed of metal, or any other material.

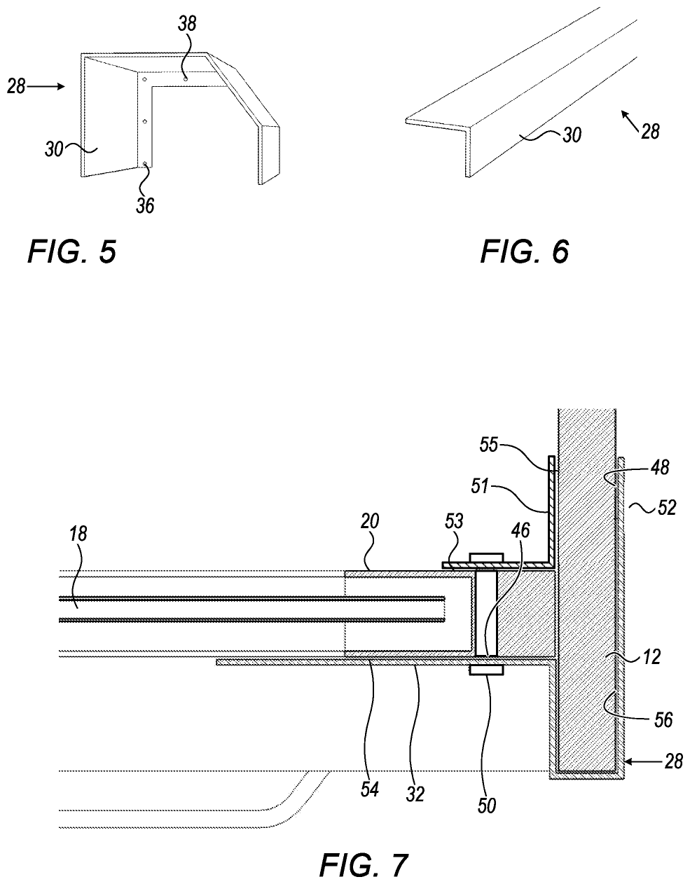

The protecting box 30 has holes 36, in order to attach it by screws 38 into the cupboard 12. The protecting box 30 can also be attached with any type of glue, adhesive material, or any other material or any combination thereof which keeps the protecting box 30 attached to the cupboard 12. The protecting box 30 is attached to a first mounting surface 40 and possibly to a second mounting surface 42 and a third mounting surface 44 adjacent the opening of the cupboard 12. The protecting box 30 is attached firmly and cannot be easily detached from the cupboard 12. The protecting box 30 covers entirely the shutter roller 22, therefore the shutter roller 22 cannot be accessed easily when the rolling shutter mechanism 10 is in its closed and locked position. The protecting box 30 may generally be “U” shaped as in FIG. 4, or any other shape, as seen for example, in FIG. 5, or as seen as an example for a window, in FIG. 6.

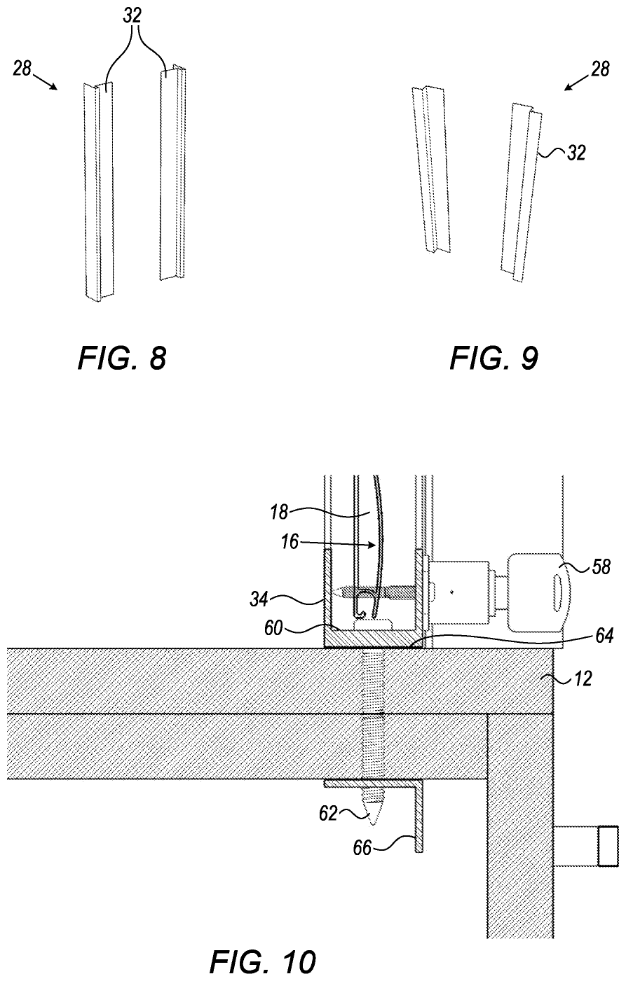

Attention is now drawn to FIG. 7, showing the protecting frames 32 covering the guide rails 20. The protecting frames 32 have holes 46, 48 in order to attach them by screws 50, 52 to the guide rails 20 and the cupboard 12 respectively. Also here, the protecting frames 32 can also be attached with any type of glue, adhesive material, or any other material or any combination thereof which keeps the protecting frames 32 attached to the guide rails 20 and the cupboard 12. The protecting frame 32 is attached to a first contact surface 54 of the guide rails 20 and to a second contact surface 56 of the cupboard 12. The protecting frames 32 may be further attached to the guide rails 20 by the same screws 50, 52, to a contact unit 51. The contact unit 51 may have any desired shape, for example an “L” shape and may be attached to a third contact surface 53 of the guide rails 20 and to a fourth contact surface 55 of the cupboard 12. In the case of two attached cupboards, the protecting frames 32 may possibly be attached to a fifth contact surface 57 of the guide rails of a cupboard attached to the cupboard 12 (not seen). The protecting box 30 is attached firmly and cannot be easily detached from the guide rails 20 and the cupboard 12. The protecting frames 32 covers entirely the guide rails 20, therefore the guide rails 20 cannot be accessed easily when the rolling shutter mechanism 10 is in its closed and locked position. The protecting frames 32 may be rectangular in shape, as seen in FIG. 8, as an example when the protecting frames 32 are attached on top of a single cupboard, or as seen in FIG. 9, as an example when the protecting frames 32 are attached on top of a window, or the protecting frames 32 may have any other shape, including a shape similar to a pi shape, of protecting frames which cover two cupboards attached together.

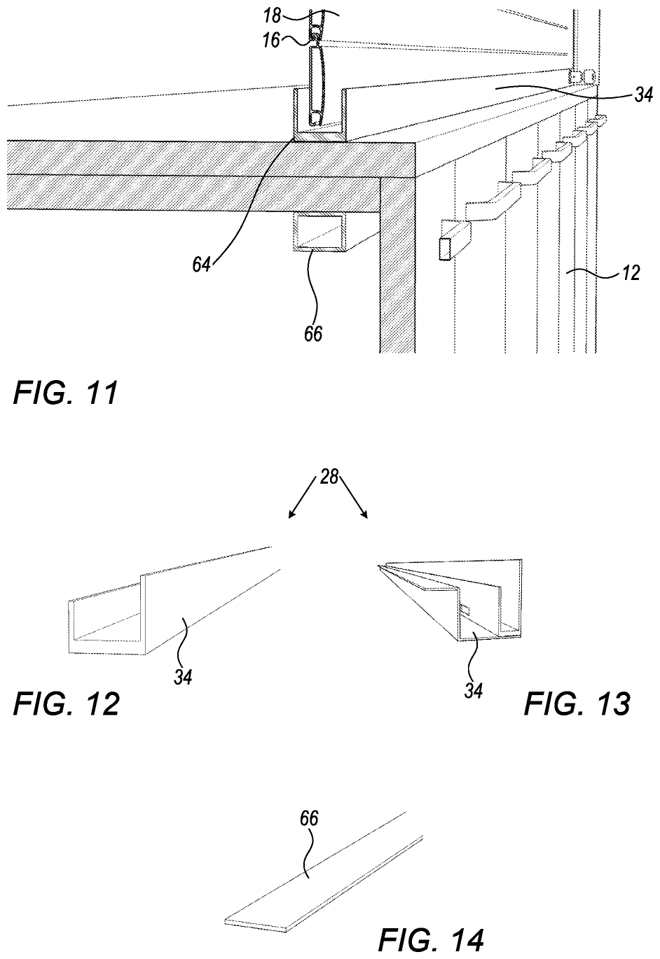

FIGS. 10 and 11 show the protecting unit 34 covering the lower part of the shutter 16, when it is in its closed position. As mentioned above, the locking mechanism can be with a key 58, with an automatic locking system 26, or any other locking system. The protecting unit 34 has holes 60, in order to attach it by screws 62 into the cupboard 12. The protecting unit 34 can also be attached with any type of glue, adhesive material, or any other material or any combination thereof which keeps the protecting unit 34 attached to the cupboard 12. The protecting unit 34 is attached to an abutment surface 64 adjacent the opening of the cupboard 12, and can generally be “U” shaped, as can be seen, for example, in FIGS. 10 and 11, or any other shape, as can be seen, for example, in FIGS. 12 and 13. The protecting unit 34 may be further attached to the cupboard 12, by the same screw 62, to an attachment unit 66. The attachment unit 66 may have any desired shape, for example an “L” shape, as can be seen in FIG. 10, a rectangular shape, as can be seen in FIG. 11, or a flat shape, as can be seen in FIG. 14. The protecting unit 34 is attached firmly and cannot be easily detached from the cupboard 12. The protecting unit 34 can also be attached with any type of glue, adhesive material, or any other material or any combination thereof which keeps the protecting unit 34 attached to the cupboard 12. The protecting unit 34 covers entirely the lower part of the shutter 16 in closed position, therefore the shutter 16 cannot be accessed easily when the rolling shutter mechanism 10 is in its closed and locked position.

In accordance with the present invention, the rolling shutter mechanism 10 is assembled by attaching the protecting means 28 in the three locations necessary to protect the rolling shutter assembly 14: placing the protecting box 30 on top of the shutter roller 22 and attaching the protecting box 30 to the first mounting surface 40 and possibly to the second mounting surface 42 and the third mounting surface 44 adjacent the opening of the cupboard 12, placing the protecting frames 32 on top of the guide rails 20 and attaching the protecting frames 32 to the first contact surface 54 of the guide rails 20 and to the second contact surface 56 of the cupboard 12, to the contact unit 51, and possibly to a fifth contact surface 57 of the guide rails of a cupboard attached to the cupboard 12 (not seen), and attaching the protecting unit 34 to the abutment surface 64 at the lower part of the opening and to the attachment unit 66.

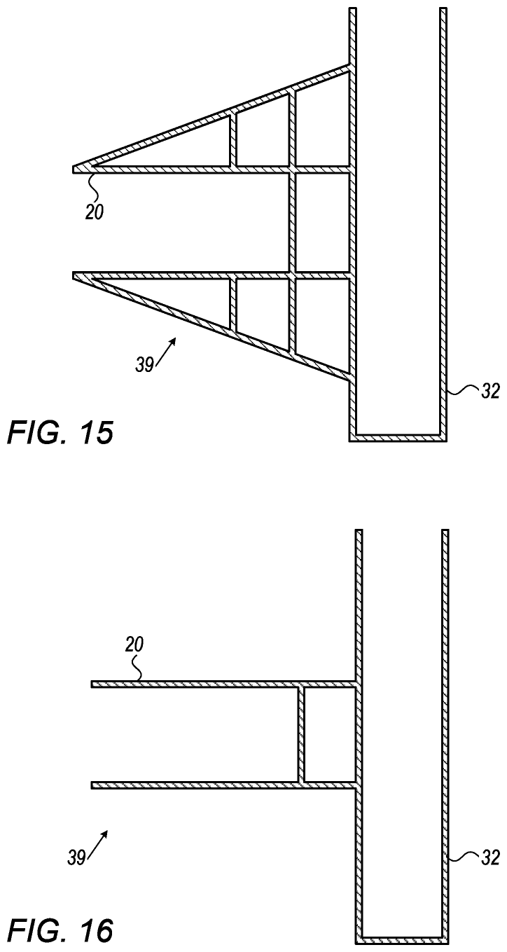

In accordance with the present invention, the rolling shutter mechanism 10 can alternatively be assembled using a different design of guide rails 39 that include protecting frames 32, as can be seen in FIGS. 15 and 16.

Using the rolling shutter protection mechanism 10 prevents a burglar from reaching the rolling shutter 14, as the burglar cannot use the regular burglary tools, and needs to break the cupboard, cabinet, window or the entrance itself completely, or to cut with a forceful tool, such as a disk-shaped cutter body, a big portion of the cupboard, cabinet or window. These actions require a great amount of time so it will significantly delay the burglar, and create a high volume noise. The result is that the chances to fail and be caught are much greater, therefore the burglar will be less inclined to do so.

Although the present invention has been described to a certain degree of particularity, it should be understood that various alterations and modifications could be made without departing from the scope of the invention as hereinafter claimed.

1. A rolling shutter mechanism (10) for protecting a rolling shutter assembly (14) covering an opening, the rolling shutter assembly (14) comprising:
a shutter (16) rolled between an open and closed position, having at least two slats (18);
guide rails (20) to guide the at least two slats (18) between the said closed and open positions;
a shutter roller (22) to roll up and down the shutter (16) when moved between said closed and open positions and store the shutter (16) rolled in its open position;
a locking mechanism (26, 58) to lock the shutter (16) in its closed position;
wherein the rolling shutter mechanism (10) comprising:
protecting means (28) to cover the rolling shutter assembly (14); wherein the protecting means (28) comprising:
protecting frames (32) covering the guide rails (20).

2. The rolling shutter mechanism (10) according to claim 1, wherein the protecting means (28) further comprising a protecting box (30) covering the shutter roller (22).

3. The rolling shutter mechanism (10) according to claim 2, wherein the protecting means (28) further comprising a protecting unit (34) located at the lower part of the opening, the protecting unit (34) covering the lower part of the shutter (16) when it is in its closed position.

4. The rolling shutter mechanism (10) according to claim 3, wherein the protecting means (28) are attached to at least one surface (40, 42, 44, 54, 56, 64) each, adjacent the opening.

5. The rolling shutter mechanism (10) according to claim 4, wherein the protecting means (28) are attached to the surfaces (40, 42, 44, 54, 56, 64) by screws (38, 50, 52, 62).

6. The rolling shutter mechanism (10) according to claim 1, wherein the protecting frames (32) are generally rectangular in shape.

7. The rolling shutter mechanism (10) according to claim 3, wherein the protecting box (30) and the protecting unit (34) are generally “U” shaped.

8. The rolling shutter mechanism (10) according to claim 4, wherein the protecting frames (32) are further attached to a contact unit (51).

9. The rolling shutter mechanism (10) according to claim 8, wherein the protecting unit (34) is further attached to an attachment unit (66).

10. The rolling shutter mechanism (10) according to claim 9, wherein the attachment unit (66) is generally rectangular in shape.

11. The rolling shutter mechanism (10) according to claim 4, wherein the protecting means (28) are attached to the surfaces (40, 42, 44, 54, 56, 64) by adhesive material.

12. The rolling shutter mechanism (10) according to claim 9, wherein the protecting means (28) are attached to the surfaces (40, 42, 44, 54, 56, 64) by the screws (38, 50, 52, 62), the contact unit (51), the attachment unit (66) and adhesive material.

13. The rolling shutter mechanism (10) according to claim 3, wherein the protecting means (28) are generally made of metal.

14. A method for protecting a rolling shutter assembly (14) for covering an opening, the rolling shutter assembly (14) comprising a shutter (16) rolled between an open and a closed position, at least two slats (18), shutter roller (22), guide rails (20) and locking mechanism (26, 58); the method comprising the steps of:
(i) providing protecting means (28) to cover the rolling shutter assembly (14); the protecting means (28) comprising a protecting box (30), protecting frames (32) and a protecting unit (34);
(ii) placing the protecting box (30) on top of the shutter roller (22) and attaching the protecting box (30) to at least one mounting surface (40, 42, 44) adjacent the opening, wherein the protecting box (30) covers the shutter roller (22);
(iii) placing the protecting frames (32) on top of the guide rails (20) and attaching the protecting frames (32) to at least one contact surface (54, 56) adjacent the guide rails (20) and the opening, wherein the protecting frames (32) cover the guide rails (20);
(iv) placing and attaching the protecting unit (34) to at least one abutment surface (64) at the lower part of the opening, wherein the protecting unit (34) covers the shutter (16) when it is in its closed position.

15. The method for protecting a rolling shutter assembly (14) according to claim 14, wherein the method further comprises in step (iii): attaching the protecting frames (32) to at least one contact surface (54, 56) adjacent the guide rails (20) and the opening via adhesive material.

16. The method for protecting a rolling shutter assembly (14) according to claim 14, wherein the method further comprises in step (iii): attaching a contact unit (51) to at least one contact surface (53, 55) adjacent the opening.

17. The method for protecting a rolling shutter assembly (14) according to claim 16, wherein the method further comprises in step (iii): attaching the protecting frames (32) to the contact unit (51) by at least one screw (50, 52);

18. The method for protecting a rolling shutter assembly (14) according to claim 14, wherein the method further comprises: attaching the protecting means (28) to the surfaces (40, 42, 44, 54, 56, 64) by the screws (38, 50, 52, 62), the contact unit (51), the attachment unit (66) and adhesive material.

19. The rolling shutter mechanism (10) according to claim 3, wherein the guide rails (20) and the protecting frames (32) are made and assembled as one unit (39).
